(19) United States
(12) Patent Application Publication
(10) Pub. No.: US 2007/0258349 A1
(43) Pub. Date: Nov. 8, 2007

(54) Information Recording Medium

(76) Inventor: Kazuo Kuroda, Saitama (JP)

Correspondence Address: YOUNG & THOMPSON, 745 SOUTH 23RD STREET, 2ND FLOOR, ARLINGTON, VA, 22202, US

(21) Appl. No.: 11/632,204

(22) PCT Filed: Jul. 13, 2005
(86) PCT No.: PCT/JP05/12898

§ 371 Date: Mar. 26, 2007

(30) Foreign Application Priority Data
Jul. 13, 2004 (JP) 2004-206182

(51) Int. Cl. G11B 3/70

(52) U.S. Cl. 369/278; 369/272.1

(57) ABSTRACT

An information recording medium is provided with a first recording information recording area (102) wherein first recording information, for instance, contents information, can be recorded by a first rotating speed control system (CLV control system), and a second recording information recording area (CDZ) wherein second recording information (Key1), for instance, encryption key, is previously recorded by a second rotating speed control system (CAV control system).

### TECHNICAL FIELD

The present invention relates to an information recording medium, such as a DVD.

### BACKGROUND ART

A patent document 1 or the like discloses a distribution or delivery system for recording in advance encryption information onto a record type information recording medium, such as a DVD-R/RW, selling it, and distributing encrypted DVD video contents (hereinafter referred to as “encrypted contents”, as occasion demands) through a network. This distribution system uses an information recording medium having the same physical structure as that of the conventional record type information recording medium, such as the DVD-R/RW. In other words, in a control area, such as a control data zone, of the record type information recording medium on which wobble for obtaining a rotational speed control signal for recording is formed, the encryption information applied to a conventional read-only type information recording medium, such as a DVD-ROM, is prerecorded before sale in a CLV (Constant Linear Velocity) control method. The CLV control method herein is a rotational speed control method which enables a linear velocity to be constant when information is recorded onto an optical disc. As the characteristics of the CLV control method, a recording density along a track is constant on the inner and outer circumferences of the optical disc, so that it is possible to realize high-density recording. However, it is necessary to control the rotational speed of a spindle motor in accordance with the radial position of the optical disc, on the basis of the rotational speed control signal for recording, obtained from the wobble. On the other hand, a CAV (Constant Angular Velocity) control method is a rotational speed control method which enables an angular velocity to be constant, i.e. the number of rotations per unit time to be constant, when the information is recorded onto the optical disc. As the characteristics of the CAV control method, the linear velocity changes in the recording on the inner and outer circumferences of the optical disc. Thus, the recording density along the track reduces on the outer circumference. As described above, although the use efficiency of the recording area of the optical disc reduces, it is possible to simplify the control of the rotational speed of the spindle motor.

Patent document 1: Japanese Patent Application Laying Open NO. 2001-307427

Patent document 2: Japanese Patent Application Laying Open NO. 2001-357001

Patent document 3: Japanese Patent Application Laying Open NO. 2000-331412

Nonpatent document 1: “DVD content protection”, Toshiba review, Vol. 58, No 6 (2003)

### DISCLOSURE OF INVENTION

### Subject to be Solved by the Invention

However, in the above-mentioned patent document 1, the record type information recording medium is not specially designed, and the encryption information having the same mechanism as the read-only type DVD (DVD-ROM) is prerecorded in the recording area having the same physical structure as that of the conventional record type information recording medium. Thus, if a disc in a not-prerecorded condition distributes in market, there is such a technical problem that the entire read-only type DVD is possibly copied to the relevant disc.

Moreover, in an existing rule about the reproduction or recording of the encrypted contents, it is not recommended that the encryption information, such as a disk key, is recorded onto the record type DVD disc. Therefore, on an information recording/reproducing apparatus, when the type of media is judged by a seek operation for obtaining control information or by similar operations, disc identification information recorded on the disc is checked. However, there is also illegal equipment capable of writing the disc identification information indicating the read-only type DVD onto the record type DVD disc. Thus, there is such a technical problem that it is hardly possible to correctly distinguish both the legal record type DVD disc and the illegal record type DVD disc only by checking the disc identification information.

It is therefore an object of the present invention to provide an information recording medium which can increase the secrecy and confidentiality of the encryption information for encrypting contents on a record type information recording medium.

### MEANS FOR SOLVING THE SUBJECT

(Information Recording Medium)

Hereinafter, the information recording medium of the present invention will be explained.

The above object of the present invention can be achieved by an information recording medium, provided with: a first record information recording area in which first record information can be recorded in a first rotational speed control method; and a second record information recording area in which second record information is recorded in advance in a second rotational speed control method different from the first rotational speed control method.

According to the information recording medium of the present invention, the rotational speed control method for recording varies between (i) the first record information recording area which occupies most part of the recording areas, such as a data area, for example, and (ii) the second record information recording area which is a relatively small area located on the inner circumferential side, such as a lead-in area, for example. Therefore, a commercial available information recording apparatus can record the first and second record information onto the information recording medium of the present invention, only under the first rotational speed control method, such as a CLV control method. Thus, it is difficult to accurately record or prerecord the second record information, such as encryption information, for example, in the second record information recording area in which the information is recorded in advance under the second rotational speed control method, such as a CAV control method, for example. Specifically, it is hardly possible or not possible at all to record a record mark with a desired length, which constitutes the second record information, such as the encryption information, in the accurate position, under the proper rotational speed control method. Incidentally, the “different rotational speed control method” or the expression that “the rotational speed control method varies” excludes a zone CAV which only simply changes the speed in stages in accordance with the radial position, for example, and it at least means a method which is different to the extent that a reproducing apparatus in which one rotational control method is set, cannot reproduce the information recorded on the information recording medium in the other rotational control method, such as the CLV for the one rotational control method and the CAV for the other rotational control method, for example.

Consequently, on the record type information recording medium, it is hardly possible or not possible at all to falsify or alternate the second record information prerecorded in the second record information recording area, for example, to unexpected information, by using a commercially available information recording apparatus. In addition, it is hardly possible or not possible at all to record the unexpected information, such as illegal encryption information, into the second record information recording area, for example.

As a result, it is possible to highly maintain the confidentiality of the second record information, such as the encryption information, which is prerecorded or can be recorded in the second record information recording area; namely, it is possible to set a secure condition for the second record information. Thus, it is hardly possible or not possible at all to prepare or manufacture the record-type information recording medium on which the second record information, such as the encryption information, is illegally copied.

In one aspect of the information recording medium of the present invention, (i) the first rotational speed control method is a rotational speed control method which enables a linear velocity to be constant, and (ii) the second rotational speed control method is a rotational speed control method which enables an angular velocity to be constant.

According to this aspect, even if wobble for obtaining a rotational speed control signal for recording is not formed in the second record information recording area, such as a control data zone, for example, of the information recording medium, it is possible to record or prerecord the second record information, such as the encryption information, in the accurate position, under the rotational speed control method which enables the angular velocity to be constant, by using a prerecording apparatus for performing the prerecording, for example. Specifically, it is possible to record or prerecord the record mark with a desired length, which constitutes the second record information, such as the encryption information, in the accurate position. Incidentally, the size of the second record information recording area, such as the control data zone, in the radial direction is extremely small, i.e. about 200 tracks, on the inner circumference of the optical disc. Therefore, it is hardly necessary or not necessary at all to change recording parameters, such as strategy, in accordance with a difference in linear velocity, when the second record information is recorded into the second record information recording area.

In an aspect associated with the rotational speed control method, the second record information recording area may include a prerecorded area in which portion of the second record information is recorded in advance in the second rotational speed control method.

By virtue of such construction, (at least one) portion of the second record information, such as the encryption information, for example, can be inevitably prerecorded only in the second rotational speed control method which enables the angular velocity to be constant, in the prerecorded area. In other words, it is possible to ensure a margin to perform the recording under the condition of the constant angular velocity, at least before or after the prerecorded area i.e., front side or rear side of the prerecorded area.

Consequently, on the record type information recording medium, it is hardly possible or not possible at all to falsify or alternate the second record information prerecorded in the second record information recording area, for example, to unexpected information, by using the commercially available information recording apparatus. In addition, it is hardly possible or not possible at all to record the unexpected information, such as illegal encryption information, into the second record information recording area, for example.

As a result, it is possible to highly maintain the confidentiality of the second record information, such as the encryption information, which is prerecorded in the second record information recording area, for example.

In another aspect of the information recording medium of the present invention, the second record information recording area at least partially includes a special area having a physical structure different from that of the first record information recording area.

According to this aspect, the commercially available information recording apparatus can record the first and second information only under the first rotational speed control method, such as the CLV control method. Thus, it is difficult to record the second record information, such as encryption information, for example, in the accurate position, if the wobble for obtaining a rotational speed control signal for recording is not formed, in the special area which is (at least one) portion of the second record information recording area. In other words, in the special area, the rotational speed control signal for recording is not obtained from the wobble, so that it is hardly possible or not possible at all to record the record mark with a desired length, which constitutes the second record information, such as the encryption information, in the accurate position, under the proper rotational speed control method, such as the CLV control method.

As a result, it is possible to highly maintain the confidentiality of the second record information, such as the encryption information, which is prerecorded or can be recorded in the special area, which is at least one portion of the second record information recording area, for example.

In an aspect associated with the above-mentioned special area, a recording track for recording the first record information may be formed in a wobbling manner in the first record information recording area, and a recording track on which portion of the second record information is recorded may be not formed in a wobbling manner in the special area.

By virtue of such construction, the prerecorded area or the second record information recording area includes the special area in which the wobble is not formed, unlike the first record information recording area. Thus, in the special area, a recording clock and a recording address based on the wobble, i.e. the rotational speed control signal for recording, are not obtained by the commercially available information recording apparatus. Thus, it is hardly possible or not possible at all to falsify or alternate the information to unexpected information, and to overwrite the unexpected information.

As a result, it is possible to highly maintain the confidentiality of the second record information, such as the encryption information, which is prerecorded or can be recorded in the second record information recording area.

Moreover, it is possible to distinguish the legal record type information recording medium and the illegal record type information recording medium, accurately and quickly, by whether or not the wobble is detected in the special area, which is (at least one) portion of the second record information recording area or the prerecorded area, by using the commercially available information recording apparatus. In addition, by that the wobble is not formed in the special area, which is (at least one) portion of the second record information recording area, it is possible to partially comply with the existing rule about the reproduction or recording of the encrypted contents.

In an aspect associated with the above-mentioned special area, wobble may be formed in the first record information recording area by that a recording track for recording the first record information meanders, and wobble in which at least one of frequency, amplitude, and phase is different from those of the wobble formed in the first record information recording area, may be formed in the special area by that a recording track for recording portion of the second record information meanders.

By virtue of such construction, the prerecorded area or the second record information recording area includes the special area in which the wobble in which at least one of frequency, amplitude, and phase is different from those of the wobble formed in the first record information recording area is formed. Thus, at least in the special area, the accurate recording clock and recording address, i.e. the rotational speed control signal for recording, are not obtained on the basis of a signal from the wobble by the commercially available information recording apparatus. Thus, it is hardly possible or not possible at all to falsify or alternate the legal information to unexpected information, such as illegal encryption information, and overwrite the unexpected information. In particular, the special area may be random-modulated in which a plurality of parameters out of the frequency, amplitude, and phase of the wobble are modulated.

As a result, it is possible to highly maintain the confidentiality of the second record information, such as the encryption information, which is prerecorded in the second record information recording area.

In an aspect associated with the above-mentioned special area, (i) a land track and a groove track may be alternately formed in the first record information recording area as a recording track, and (ii) land pre-pits carrying predetermined types of pre-information are formed in advance on the land track, and the land pre-pits may be not recorded in the special area.

By virtue of such construction, it is possible to highly maintain the confidentiality of the second record information, such as the encryption information, which is prerecorded in the second record information recording area.

In this case, further, the land track and the groove track may be formed in the special area.

By virtue of such construction, it is possible to highly maintain the confidentiality of the second record information, such as the encryption information, which is prerecorded in the second record information recording area, while inhibiting the complexity of a process of manufacturing the information recording medium.

In an aspect associated with the above-mentioned special area, a land track and a groove track may be alternately formed in the first record information recording area as a recording track, and the land track and the groove track may be not recorded in the special area.

By virtue of such construction, it is possible to highly maintain the confidentiality of the second record information, such as the encryption information, which is prerecorded in the second record information recording area.

In an aspect associated with the above-mentioned rotational speed control method, the information recording medium may be further provided with a control information recording area in which control information about reproduction and recording control can be recorded, at least one of start address information and end address information being recorded in the control information recording area, the start address information indicating a start position of the second record information recording area, the end address information indicating an end position of the second record information recording area.

By virtue of such construction, at least one of the start address information and the end address information, recorded in the control information recording area, is obtained by the initial operation of the prerecording apparatus for performing the prerecording, for example, wherein the start address information indicates the start position of the second record information recording area and the end address information indicates the end position of the second record information recording area. Therefore, it is possible to quickly identify the position of the second record information recording area by using the prerecording apparatus.

As a result, by that the prerecording apparatus identifies the physical structure in the second record information recording are, it is possible to distinguish the legal record-type information recording medium and the illegal record-type information recording medium, accurately and quickly.

In an aspect associated with the above-mentioned rotational speed control method, pre-format address information may be recorded in at least one of the first record information recording area and the second record information recording area, and at least one of start address information and end address information may be appended to the pre-format address information, the start address information indicating a start position of the second record information recording area, the end address information indicating an end position of the second record information recording area.

By virtue of such construction, at least one of the start address information and the end address information, appended to the pre-format address information in at least one of the first record information recording area and the second record information recording area, can be obtained by the prerecording apparatus for performing the prerecording, for example, wherein the start address information indicates the start position of the special area and the end address information indicates the end position of the special area. Here, the expression “appended” or “appended to the pre-format address information” means that information is recorded in the same method as in the pre-format address information, such as address information by pre-pits, for example, or as pre-information inserted before or after the arrangement (i.e., front position or rear position of the arrangement) of the pre-format address information or inserted in the middle of the arrangement of the pre-format address information. Therefore, it is possible to quickly identify the position of the special area by the prerecording apparatus.

As a result, by that the prerecording apparatus identifies the physical structure in the second record information recording area, it is possible to distinguish the legal record-type information recording medium and the illegal record-type information recording medium, accurately and quickly.

In another aspect of the information recording medium of the present invention, the second record information is encryption information for encrypting the first record information.

According to this aspect, it is possible to highly maintain the confidentiality of the second record information, such as the encryption information, which is prerecorded in the second record information recording area.

In another aspect of the information recording medium of the present invention, the second record information (e.g. a disk key) is information for further encrypting another encryption information (e.g. a title key) for encrypting the first record information, and the another encryption information is recorded into the first record information recording area with the first record information.

According to this aspect, it is possible to make the correlation of the encryption information, such as an encryption key, in a hierarchy structure. Therefore, it is possible for an owner of copyright and a disc manufacturer or the like to arbitrarily set the encryption key, to thereby establish a highly convenient encryption system.

These effects and other advantages of the present invention will become more apparent from the following embodiment.

As explained above, according to the information recording medium of the present invention, it is provided with the first record information recording area and the second record information recording area. Thus, it is possible to highly maintain the confidentiality of the second record information, such as the encryption information, which is prerecorded or can be recorded in the second record information recording area; namely, it is possible to set a secure condition.

### BRIEF DESCRIPTION OF DRAWINGS

FIG. 1 is a substantial plan view showing the basic structure of an optical disc having a plurality of recording areas in an embodiment of the information recording medium of the present invention in an upper part, and a corresponding conceptual view showing a recording area structure in the radial direction in a lower part.

FIG. 2 is a partially enlarged perspective view showing the recording surface of the optical disc in the embodiment.

FIG. 3 are schematic conceptual views showing a recording clock and a recording address required in recording, obtained from wobbling of a groove track on the optical disc in the embodiment of the information recording medium of the present invention.

FIG. 4 is a schematic conceptual view showing one specific example of the physical structure of the recording areas of the optical disc in the embodiment of the information recording medium of the present invention.

FIG. 5 is a schematic conceptual view showing various properties if a CAV control method is adopted on a general optical disc.

FIG. 6 is a schematic conceptual view showing various properties if a CLV control method is adopted on a general optical disc.

FIG. 7 are schematic conceptual views showing a wobble signal, obtained from a special area, which is at least one portion of a control data zone, in another specific example of the optical disc in the embodiment of the information recording medium of the present invention.

FIG. 8 is a block diagram showing the entire structure of an information recording/reproducing apparatus for prerecording encryption information onto the information recording medium of the present invention and reproducing record information, such as contents.

FIG. 9 is a flowchart showing a prerecording operation on a prerecording apparatus in the embodiment.

FIG. 10 is a block diagram showing the entire structure of a distribution system provided with: an information recording/reproducing apparatus for performing a recording operation; and an information distributing apparatus for performing a distribution operation, with respect to the information recording medium of the present invention.

FIG. 11 is a flowchart showing the distribution process on the information recording medium, the information recording/reproducing apparatus, and the information distributing apparatus of the present invention.

FIG. 12 is a flowchart showing a flow of a reproduction operation by a specific example of the embodiment of the information recording/reproducing apparatus of the present invention.

### DESCRIPTION OF REFERENCE CODES

1 . . . center hole, 10 . . . track, 11 . . . sector, 100 . . . optical disc, 101 . . . lead-in area, 102 . . . data area, 103 . . . lead-out area, 106 . . . transparent substrate, 107 . . . recording layer, 108 . . . reflective film, 109 . . . wobble, 200 . . . prerecording apparatus, 200a . . . information recording/reproducing apparatus, 201 . . . objective lens, 202 . . . optical pickup, 203 . . . spindle motor, 204 . . . head amplifier, 210 . . . sum generation circuit, 211 . . . pit data demodulation circuit, 212 . . . pit data correction circuit, 213 . . . buffer, 214 . . . interface, 220 . . . push-pull signal generation circuit, 221 . . . low pass filter, 222 . . . servo unit, 225 . . . LPP detection circuit, 229 . . . error correction circuit, 230 . . . LPP demodulation circuit, 250 . . . CPU, 300 . . . information distributing apparatus, 400 . . . external network, SS . . . spread spectrum data, CK1 . . . first clock signal, GT . . . groove track, LT . . . land track, LB . . . laser light, LPP . . . land pre-pit, Key1 . . . encryption information (disk key, disk key set), Key2 . . . encryption information (title key), CDZ . . . control data zone, CDZa . . . special area, NBCA . . . Narrow Burst Cutting Area

### BEST MODE FOR CARRYING OUT THE INVENTION

Hereinafter, the best mode for carrying out the present invention will be discussed by giving embodiments on the basis of the drawings.

(Information Recording Medium)

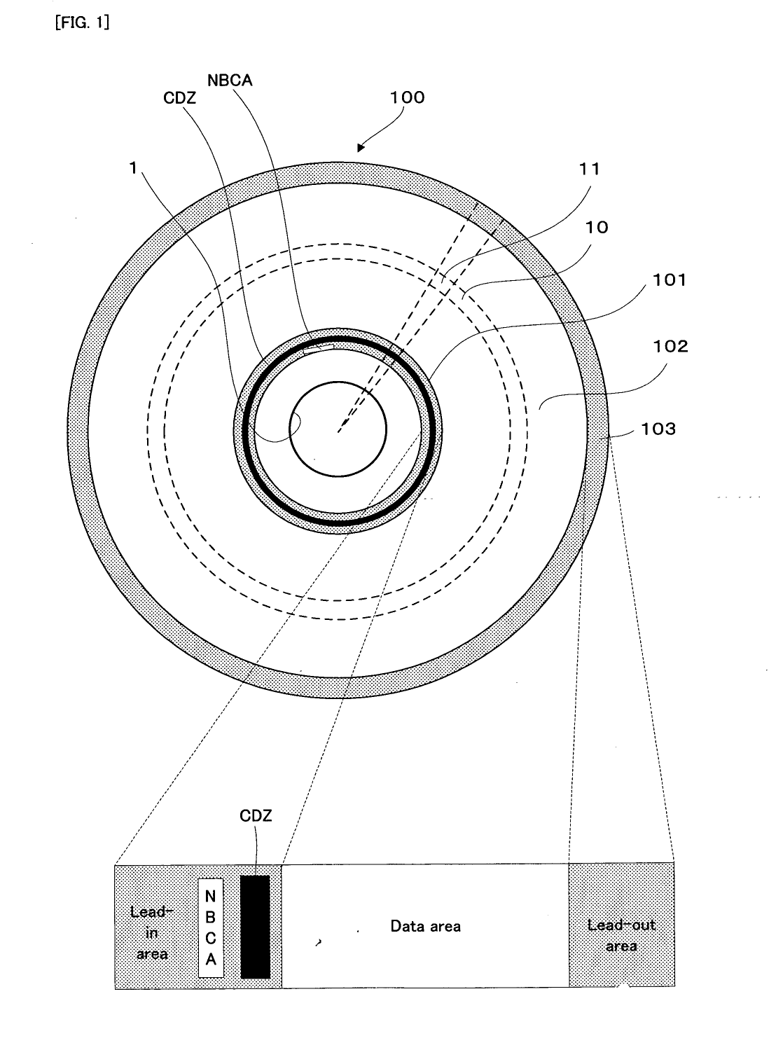

Hereinafter, with reference to FIG. 1 to FIG. 7, an embodiment of the information recording medium of the present invention will be explained.

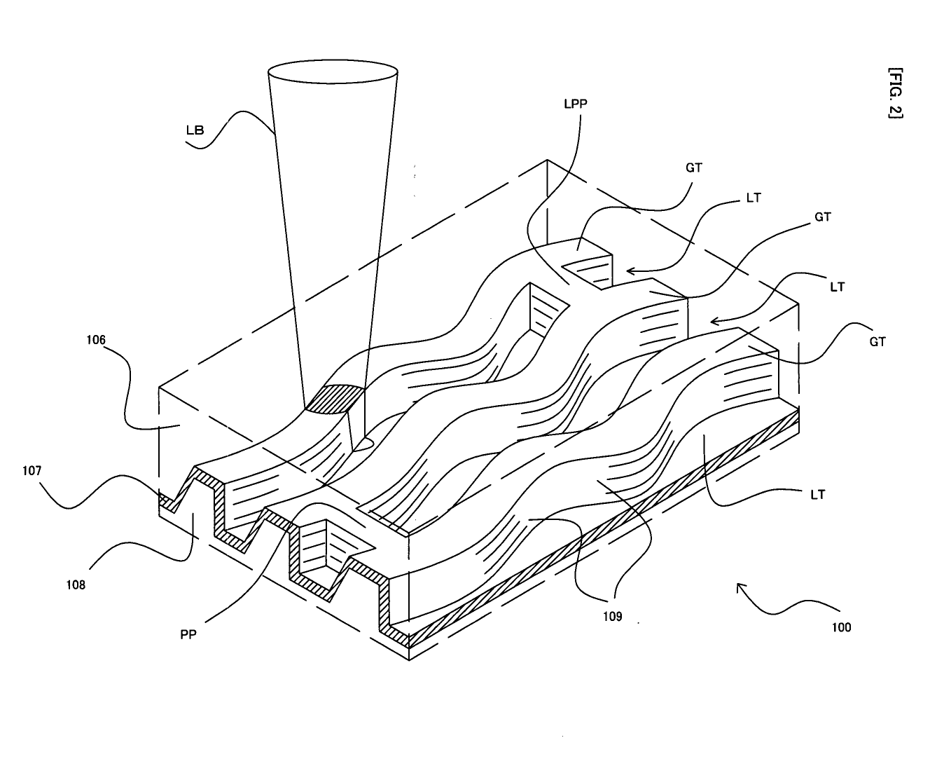

Firstly, with reference to FIG. 1 and FIG. 2, an explanation will be given for the basis structure of an optical disc, which is one specific example of the information recording medium of the present invention. FIG. 1 is a substantial plan view showing the basic structure of the optical disc having a plurality of recording areas in the embodiment of the information recording medium of the present invention in an upper part, and a corresponding conceptual view showing a recording area structure in the radial direction in a lower part. Moreover, FIG. 2 is a partially enlarged perspective view showing the recording surface of the optical disc in the embodiment.

The information recording medium in the embodiment is an additional recording type (write-once type) optical disc which uses an organic pigment film. Incidentally, as described later, the information recording medium in the embodiment may be a rewritable type optical disc on which recording can be performed many times and reproduction can be also performed many times in various irreversible change recording methods by heat or the like.

As shown in FIG. 1, an optical disc 100 has a recording surface on a disc main body with a diameter of about 12 cm, as is a DVD. On the recording surface, the optical disc 100 is provided with: a center hole 1 as the center; a lead-in area 101 as a buffer area in the embodiment; a data area 102; and a lead-out area 103 as another buffer area, from the inner to the outer circumferential side.

The lead-in area 101 is provided with a control data zone CDZ. In the control data zone CDZ, as one portion of the control information for controlling the reproduction and the recording with respect to the optical disc 100, encryption information Key1, such as a disk key and a disk key set, based on a predetermined encryption system is prerecorded. Incidentally, the encryption information Key1, such as a disk key and a disk key set, constitutes one specific example of the “second record information” of the present invention.

Moreover, the lead-in area 101 is provided with a NBCA (Narrow Band Cutting Area). In the NBCA, a serial number peculiar to each optical disc 100, i.e. media ID, is recorded in a barcode-shaped pattern by laser cutting. Incidentally, one specific example of the “second record information recording area” is constructed from the control data zone CDZ. Moreover, the control data zone CDZ is constructed to include a special area CDZa described later.

In the data area 102, encryption information Key2, such as a title key, based on the encryption system, and encrypted contents encrypted by the encryption information Key2, such as a title key, are recorded. More specifically, the encryption information Key2, such as a title key, is encrypted by using the encryption information Key1, such as a disk key and a disk key set. Incidentally, the “another encryption information” of the present invention is constructed from the encryption information Key2, such as a title key. Moreover, one specific example of the “first record information recording area” of the present invention is constructed from the data area 102.

Then, in each recording area, a track or tracks 10, such as a groove track and a land track, are alternately placed, spirally or concentrically, centered on the center hole 1.

As shown in FIG. 2, in the embodiment, the optical disc 100 has a pigment type recording layer 107, which constitutes an information recording surface, laminated on the lower side of a disc-shaped transparent substrate 106, and further has a reflective film 108 on the lower side thereof. On the information recording surface constructed from the surface of the recording layer 107, a groove track GT and a land track LT are alternately formed. Incidentally, upon recording and reproduction of the optical disc 100, for example, as shown in FIG. 2, the groove track GT is irradiated with laser light LB through the transparent substrate 106. For example, upon recording, the laser light LB is irradiated with a recording laser power, to thereby perform the recording with respect to the recording layer 107 in accordance with the record data. On the other hand, upon reproduction, the laser light LB is irradiated with a reproduction laser power weaker than the recording laser power, by which the record data recorded in the recording layer 107 is read.

Incidentally, the groove track GT, the land track LT, wobble 109, and a land pre-pit LPP and the like will be explained in detail later.

In FIG. 1 again, on the track 10, data is divided and recorded by a unit of 1ECC block (cluster), which is a management unit composed of 16 units of sectors 11. The 1ECC block is a management unit of managing information by using error-correctable pre-format address information.

Incidentally, the present invention is not particularly limited to the optical disc having these four recording areas shown in FIG. 1. For example, the presence of the lead-in area 101 and the lead-out area 103 is arbitrary. It is only necessary to provide at least the data area 102 in which the record data is recorded and a not-illustrated recording area of PCA (Power Calibration Area) for detecting an optimum recording power.

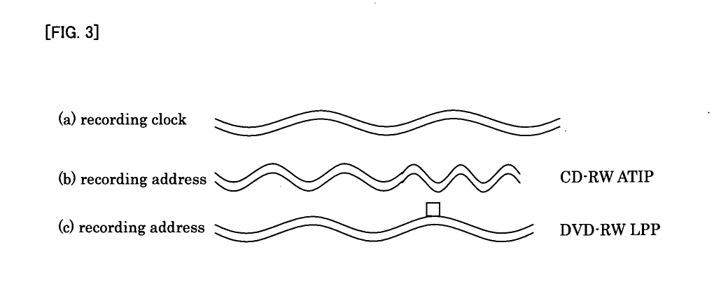

Next, with reference to the above-mentioned FIG. 2, as occasion demands, in addition to FIG. 3, an explanation will be given for a recording clock and a recording address required in recording, obtained from wobbling of the groove track on the optical disc in the embodiment of the information recording medium of the present invention. FIG. 3 are schematic conceptual views showing the recording clock and the recording address required in recording, obtained from wobbling of the groove track on the optical disc in the embodiment of the information recording medium of the present invention.

As shown in FIG. 3(a), (b), and (c), on the optical disc in the embodiment, the groove track GT is oscillated or wobbled with a constant amplitude and at a constant spatial frequency. In other words, the groove track GT is wobbled, and the cycle of the wobble 109 is set to a predetermined value. Incidentally, it is also possible to record the pre-format address information in advance, by modulating the wobble 109 of the groove track GT in a predetermined modulation method, such as frequency modulation and phase modulation.

As shown in FIG. 3(b), for example, in the case of a CD-R/W, the recording address on the optical disc is incorporated as absolute time information, referred to as an ATIP (Absolute Time In Pre-groove) signal, by a slight change in frequency.

As shown in FIG. 3(c), for example, in the case of a DVD-R/W, an address pit referred to as a land pre-pit LPP, indicating the pre-format address information, is formed on the land track LT.

By virtue of the two addressing, i.e. the wobble 109 and the ATIP or the land pre-pit LPP, it is possible to obtain information necessary for rotational speed control during the recording, generation of the recording clock, or data recording, such as the recording address. More specifically, in order that a recording drive, such as a disk drive, for example, performs writing into the data area, which constitutes one example of the “first record information recording area” of the present invention, the recording clock and the recording address used for the writing are necessary in addition to recording parameters, such as an optimum recording power of laser light and recording strategy.

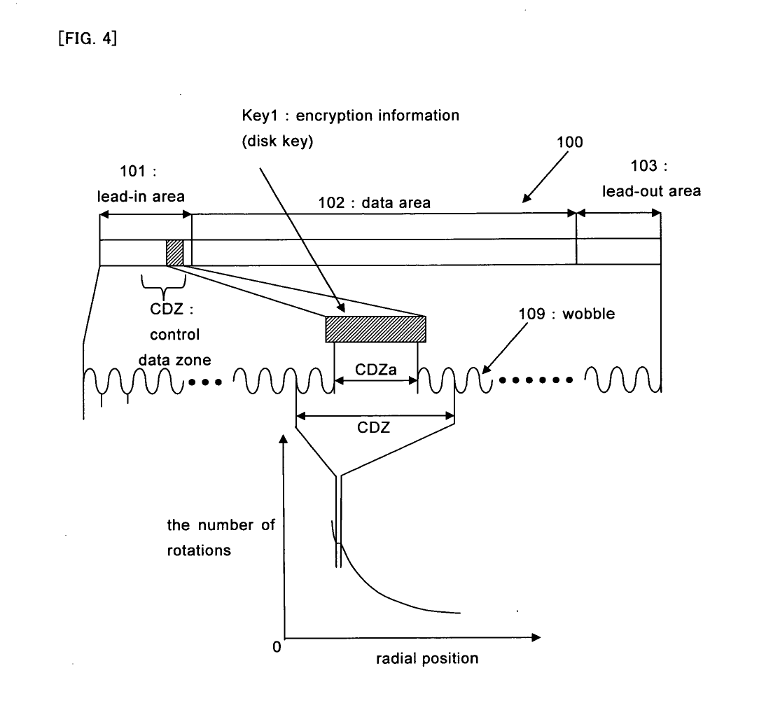

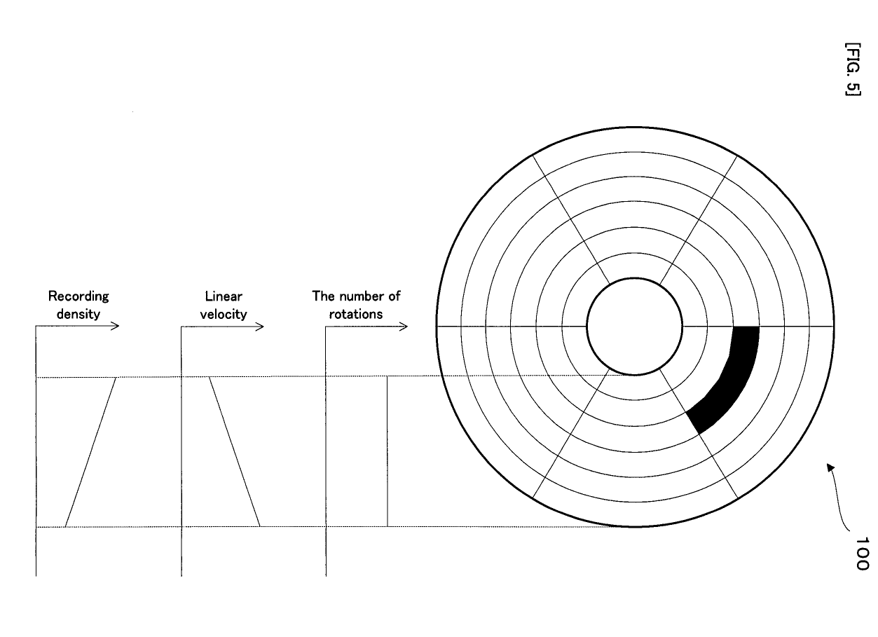

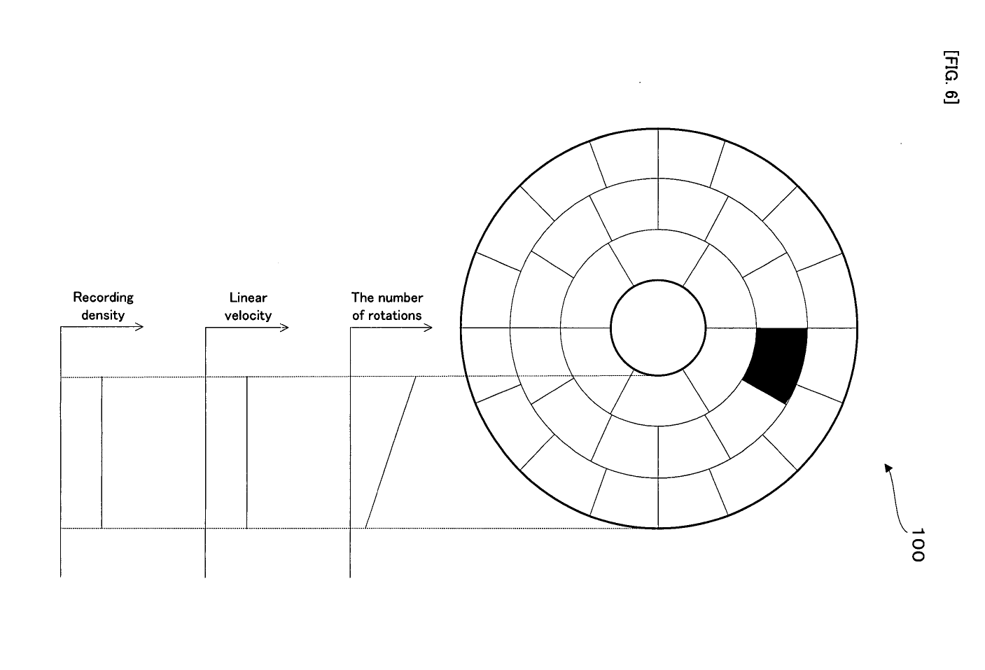

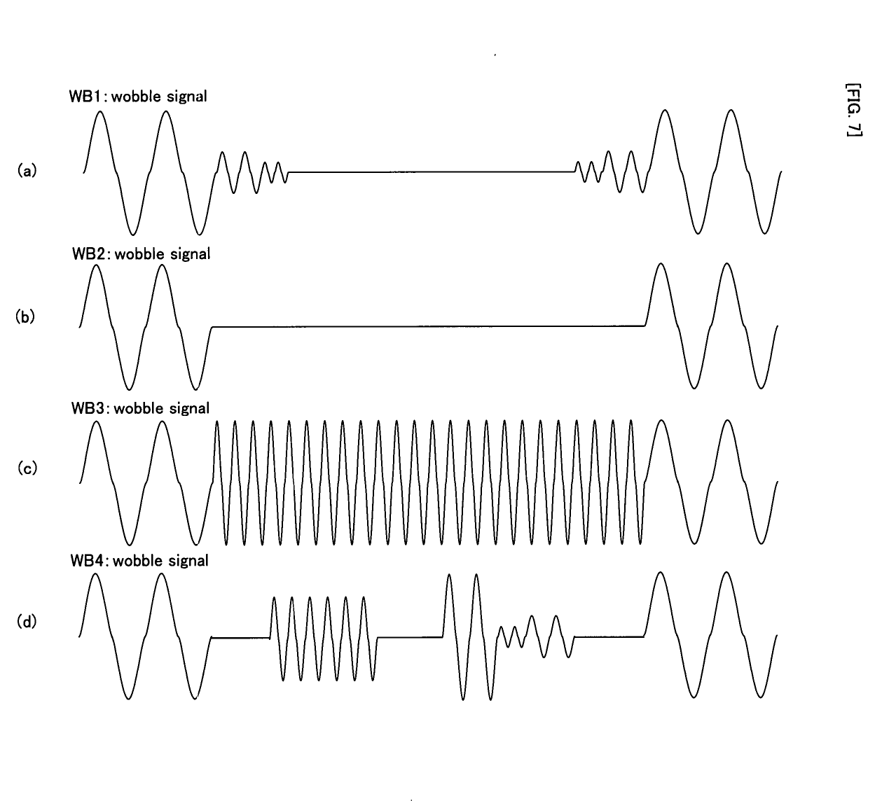

Next, with reference to FIG. 4 to FIG. 7, a more detailed explanation will be given for a specific example of the physical structure of the recording area of the optical disc in the embodiment of the information recording medium of the present invention. FIG. 4 is a schematic conceptual view showing one specific example of the physical structure of the recording areas of the optical disc in the embodiment of the information recording medium of the present invention. FIG. 5 is a schematic conceptual view showing various properties if a CAV control method is adopted on a general optical disc. FIG. 6 is a schematic conceptual view showing various properties if a CLV control method is adopted on a general optical disc. FIG. 7 are schematic conceptual views showing a wobble signal, obtained from a special area, which is (at least one) portion of a control data zone, in another specific example of the optical disc in the embodiment of the information recording medium of the present invention.

As shown in FIG. 4, the optical disc 100 in the embodiment is provided with at portion (or least one portion) of the control data zone CDZ in which the encryption information Key1, such as a disk key, is prerecorded, as a special area CDZa. In the special area CDZa, there is no wobble 109 formed.

In particular, in the control data zone CDZ of the optical disc 100 in the embodiment, a rotational speed control method which enables an angular velocity to be constant, such as a CAV control method, is adopted. Thus, even if the wobble 109 for obtaining a rotational speed control signal for recording is not formed, the encryption information Key1 can be prerecorded in an accurate position only by a prerecording apparatus for performing the prerecording. Specifically, it is possible to prerecord a record mark with a desired length, which constitutes the encryption information Key1, in the accurate position.

More specifically, as shown in the lower part of FIG. 4 and as shown in FIG. 5, the CAV control method is the rotational speed control method which enables an angular velocity to be constant, i.e. the number of rotations per unit time to be constant, when the information is recorded onto the optical disc. Thus, in the CAV control method, a linear velocity changes in the recording on the inner and outer circumferences of the optical disc. Thus, it is possible to simplify the control of the rotational speed of a spindle motor. Incidentally, the size of the control data zone CDZ in the radial direction is extremely small, i.e. about 200 tracks, on the inner circumference of the optical disc. Therefore, it is hardly necessary or not necessary at all to change the recording parameters, such as the recording strategy, in accordance with a change in linear velocity, when the encryption information Key1 is recorded into the control data zone CDZ in which the CAV control method is applied.

On the other hand, as shown in the lower part of FIG. 4 and as shown in FIG. 6, a CLV control method is applied in (i) the lead-in area 101 other than the control data zone CDZ, (ii) the data area 102, and (iii) the lead-out area 103 of the optical disc 100 in the embodiment. In the CLV control method, it is possible to (i) increase the number of rotations per unit time on the inner circumferential side of the optical disc 100, and (ii) reduce the number of rotations per unit time on the outer circumferential side. Therefore, when the information is recorded into the three recording areas, it is possible to make the linear velocity constant, by controlling the rotational speed of the spindle motor, in accordance with the radial position of the optical disc, on the basis of the rotational speed control signal for recording, obtained from the wobble.

Therefore, a commercially available information recording apparatus, such as a disk drive, can hardly or cannot overwrite at all at least the encryption information Key1, such as a disk key, recorded in the special area CDZa, to record unexpected information, such as illegal encryption information. In addition, it is hardly possible or not possible at all to falsify or alternate information to the unexpected information, such as illegal encryption information, by using the general information recording apparatus. More specifically, the general information recording apparatus can only record the information under the CLV control method. The general information recording apparatus records the information into the control data zone CDZ in which the CAV control method is applied, under such a condition that the rotational speed is slower than a general CAV control method, so that there arises a position shift between the encryption information Key1 and the illegal encryption information recorded in the special area CDZa. Moreover, in the special area CDZa, (i) the wobble 109 and (ii) the ATIP or the land pre-pit LPP cannot be detected. Thus, the general information recording apparatus cannot generate the recording clock. Therefore, it cannot perform the rotation control of the disc during the recording in the special area CDZa. Moreover, the general information recording apparatus cannot obtain even the information necessary for the recording of the data, such as the recording address.

As a result, it is possible to highly maintain the confidentiality of the encryption information Key1 prerecorded in the control data zone CDZ; namely, it is possible to set a secure condition. Thus, it is hardly possible or not possible at all to prepare or manufacture the record type optical disc on which the encryption information Key1 is illegally copied.

Moreover, it is possible to distinguish the legal record type optical disc and the illegal record type optical disc, accurately and quickly, by whether or not the wobble is detected in the special area CDZa, which is at least one portion of the control data zone CDZ, by a general information recording/reproducing apparatus, such as a DVD player. More specifically, the type of the optical disc is judged by a seek operation for obtaining the control information about the reproduction or recording or by similar operations, performed by an information recording/reproducing apparatus 200a described later. In this case, in the special area, which is at least one portion of the control data zone CDZ, it is detected whether or not there is the wobble 109 unique to the record type optical disc. By whether or not the wobble 109 is detected, it is possible to accurately distinguish the legal record type optical disc and the illegal record type optical disc. Namely, if the wobble 109 is not detected in the special area CDZa, it can be judged to be the legal record type optical disc. On the other hand, if the wobble 109 is detected in the special area CDZa, it can be judged to be the illegal record type optical disc.

In addition, by that the wobble 109 is not formed in the special area CDZa, which is at least one portion of the control data zone CDZ, it is possible to partially comply with the existing rule about the reproduction or recording of the encrypted contents. More specifically, it is possible to partially comply with a rule of not recommending the recording of the encryption information, such as a disk key, onto the optical disc with the wobble formed, i.e. the record type optical disc; in other words, a rule of recommending the recording of the encryption information only on the optical disc without the wobble, i.e. the read-only type optical disc. Incidentally, the general information recording/reproducing apparatus 200a described later is constructed to eject the optical disc which does not comply with the existing rule.

Next, with reference to FIG. 7, another specific example of the optical disc in the embodiment of the information recording medium of the present invention will be explained.

In another specific example of the optical disc in the embodiment of the information recording medium of the present invention, the special area CDZa may be constructed so as to obtain a wobble signal WB1 as shown in FIG. 7(a), from the special area CDZa, which is at least one portion of the control data zone CDZ. More specifically, the amplitude of the wobble is reduced and amplitude-modulated in the front of the special area CDZa, on the basis of a recording track direction. On the other hand, in the rear of the special area CDZa, the amplitude of the wobble is increased and amplitude-modulated. In particular, it is preferable to change it gradually, in reducing and increasing the amplitude. This is because it can realize further simplification of a manufacturing process. More specifically, the comparator of the information recording/reproducing apparatus 200a described later cannot detect the wobble signal from a band pass filter.

In another specific example of the optical disc in the embodiment of the information recording medium of the present invention, the special area CDZa may be constructed so as to obtain a wobble signal WB2 as shown in FIG. 7(b), from the special area CDZa, which is at least one portion of the control data zone CDZ. More specifically, it may be constructed such that the wobble is almost or completely eliminated in the entire special area CDZa, so that the wobble WB2 is not obtained. However, higher control is required in the manufacturing process. Even in this specific example, as in the above-mentioned specific example, the comparator of the information recording/reproducing apparatus 200a cannot detect the wobble signal from a band pass filter.

In another specific example of the optical disc in the embodiment of the information recording medium of the present invention, the special area CDZa may be constructed so as to obtain a wobble signal WB3 as shown in FIG. 7(c), from the special area CDZa, which is at least one portion of the control data zone CDZ. More specifically, it may be constructed such that the frequency of the wobble is modulated from 1 KHz to 10 KHz, for example, and is frequency-modulated, in the entire special area CDZa. Incidentally, in the frequency modulation (FM), the frequency may be increased to two times, five times, or the like, and may be reduced to ½, ⅕, or the like. Even in this specific example, as in the above-mentioned specific example, the comparator of the information recording/reproducing apparatus cannot detect the wobble signal from a band pass filter.

In another specific example of the optical disc in the embodiment of the information recording medium of the present invention, the special area CDZa may be constructed so as to obtain a wobble signal WB4 as shown in FIG. 7(d), from the special area CDZa, which is at least one portion of the control data zone CDZ. More specifically, it may be constructed such that at least one of the frequency, amplitude, and phase of the wobble is modulated in the special area CDZa. Even in this specific example, as in the above-mentioned specific example, the comparator of the information recording/reproducing apparatus cannot detect the wobble signal from a band pass filter.

In another specific example of the optical disc in the embodiment of the information recording medium of the present invention, it may be also constructed such that the recording track, such as the groove track, itself is not formed in advance in the special area CDZa, which is at least one portion of the control data zone CDZ, which is not illustrated. Even in this specific example, as in the above-mentioned specific example, the comparator of the information recording/reproducing apparatus cannot detect the wobble signal from a band pass filter.

As described above, in the special area CDZa in the control data zone CDZ, the accurate recording track and the accurate recording address are not obtained on the basis of the signal from the wobble by the general information recording/reproducing apparatus. Thus, it is hardly possible or not possible at all to overwrite the encryption information Key1, such as a disk key, prerecorded in the control data zone CDZ, on the unexpected information, such as illegal encryption information, and to falsify information to the unexpected information, such as the illegal encryption information.

(Information Recording/Reproducing Apparatus for Prerecording)

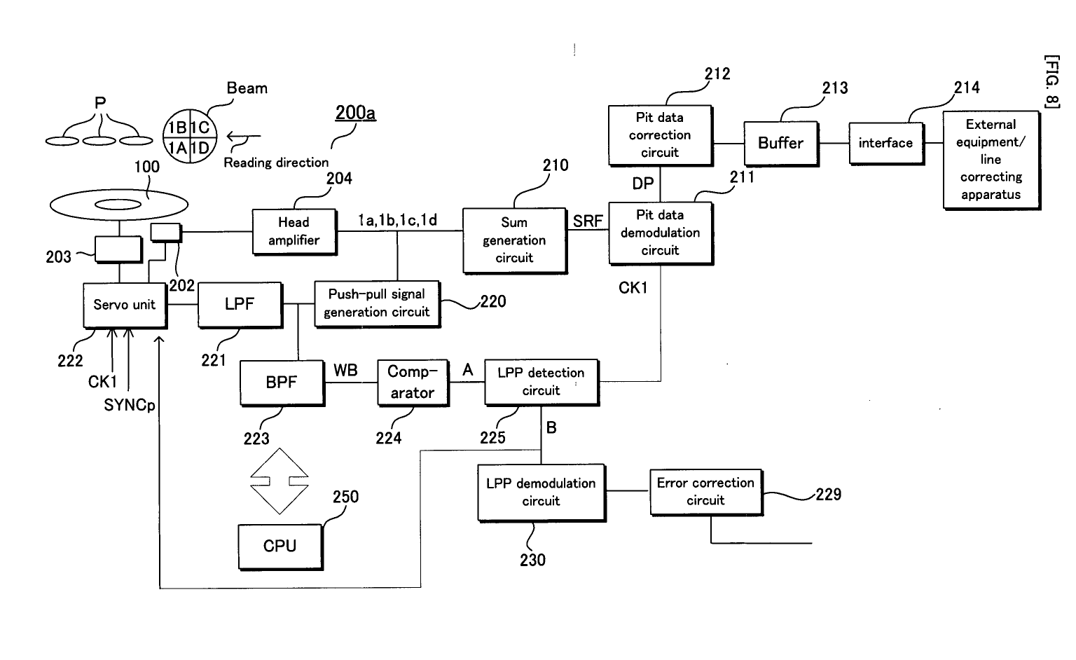

Next, with reference to FIG. 8, an explanation will be given for an information recording/reproducing apparatus for prerecording the encryption information onto the information recording medium of the present invention and reproducing the record information, such as contents. The information recording/reproducing apparatus 200a may include a prerecording apparatus 200. FIG. 8 is a block diagram showing the entire structure of the information recording/reproducing apparatus for prerecording the encryption information onto the information recording medium of the present invention and reproducing the record information, such as contents. On the optical disc 100, pit data DP synchronized with a first clock signal CK1 is recorded in accordance with the length of a record mark. The record mark in this example is a pit, and the track is constructed from a pit row. The track has a meandering shape in accordance with a wobble signal WB. The wobble signal WB is synchronized with the first clock signal CK1.

The information recording/reproducing apparatus 200a is provided with: an optical pickup 202 for irradiating a reproduction beam onto the optical disc 100 and outputting a signal responding to reflected light; a spindle motor 203 for controlling the rotation of the optical disc 100; and a servo unit 222. The first clock signal CK1 and a pit synchronization signal SYNCp are supplied to the servo unit 222. The servo unit 222 is synchronized with these signals, and performs spindle servo for controlling the rotation of the spindle motor 203, and focus servo and tracking servo for performing relative position control of the optical pickup 202 to the optical disc 100.

The optical pickup 202 is provided with a laser diode for irradiating the reproduction beam; and a four-division detection circuit (not-illustrated). The four-division detection circuit divides the reflected light of the reproduction beam into four areas 1A, 1B, 1C, and 1D shown in FIG. 8, and outputs each signal corresponding to the quantity of light in respective one of the areas. A head amplifier 204 amplifies each output signal of the optical pickup 202, and outputs a divisional read signal 1a corresponding to the area 1A, a divisional read signal 1b corresponding to the area 1B, a divisional read signal 1c corresponding to the area 1C, and a divisional read signal 1d corresponding to the area 1D. Incidentally, the optical pickup 202 and the head amplifier 204 correspond to the optical pickup device of the present invention.

A sum generation circuit 210 is provided with an adder circuit for adding the divisional read signals 1a, 1b, 1c, and 1d and for outputting a sum read signal SRF. Incidentally, the sum read signal SRF is a signal which represents the length of the record mark.

A pit data demodulation circuit 211 reproduces the pit data DP on the basis of the sum read signal SRF, and generates the first clock signal CK1. More specifically, the reproduced pit data DP is demodulated by using a predetermined table, to thereby generate reproduction data. For example, if EFM modulation is adopted as a modulating method, a process of converting 14-bit pit data DP to 8-bit reproduction data is performed. Then, a descramble process is performed in which the order of the reproduction data is rearranged in accordance with a predetermined rule, and the processed reproduction data is outputted.

The reproduction data obtained in this manner is supplied to a pit data correction circuit 212 shown in FIG. 8, on which an error correction process and an interpolation process are performed, and then, it is stored into a buffer 213. An interface 214 sequentially reads the data stored in the buffer 213, converts it in a predetermined output format, and outputs it to external equipment. Moreover, through this interface 214, the various data is inputted and outputted to the above-mentioned line connecting apparatus connected to an external network 400, for example.

A push-pull signal generation circuit 220 calculates (1a+1d)−(1b+1c) and generates a push-pull signal. The component (1a+1d) corresponds to the areas 1A and 1D which are on the left side with respect to the reading direction, while the component (1b+1c) corresponds to the areas 1B and 1C which are on the right side with respect to the reading direction. Namely, if the reproduction beam is disproportionately on the left with respect to the pit, the push-pull signal is positive on the basis of the center of amplitude. If the reproduction beam is located in the center of the pit, the value of the push-pull signal is in the center of amplitude. If the reproduction beam is disproportionately on the right with respect to the pit, the push-pull signal is negative on the basis of the center of amplitude. The relative position of the reproduction beam and the pit varies depending on the meandering of the track, and the value of the push-pull signal indicates a relative position relationship between the reproduction beam and the pit. Namely, the push-pull signal is a signal corresponding to the meandering of the track.

The push-pull signal is outputted to the servo unit 222 through a low pass filter 221. The servo unit 222 performs the tracking control on the basis of the push-pull signal. Moreover, the push-pull signal is supplied to a band pass filter 223. The passband of the band pass filter 223 is set to extract the wobble signal WB obtained by the spread spectrum modulation of the wobble data DW from the push-pull signal at the time of recording. Therefore, the band pass filter 223 constitutes the above-mentioned detecting device, together with the push-pull signal generation circuit 220, and its output signal is obtained by reproducing the wobble signal WB from the optical disc 100. In particular, on a comparator 224, if it is tried to perform the illegal writing into the encryption information recording area, the recording clock and the recording address cannot be detected in the special area of the present invention, so that errors occur in the recording operation, and the recording operation is stopped. Thus, it is possible to prevent the illegal writing into the encryption information recording area, regardless of the specification of the information recording apparatus and its recording control procedure. Namely, it is possible to make PLL (Phase Lock Loop) out of control.

A LPP detection circuit 225 is constructed to detect a LPP signal on the basis of an output signal A from the comparator 224 and the first clock signal CK1 generated on the pit data demodulation circuit 211. Then, it is constructed to output the LPP signal B to a LPP demodulation circuit 230 and the servo unit 222.

The LPP demodulation circuit 230 is constructed to demodulate the LPP signal B to the pre-format address information. Then, it is constructed to output the pre-format address information to an error correction circuit 229.

The error correction circuit 229 performs error correction on the pre-format address information, which is demodulated by the LPP demodulation circuit 230.

A CPU 250 controls each of the constitutional elements of the information recording/reproducing apparatus 200a.

(Prerecording Operation of Prerecording Apparatus)

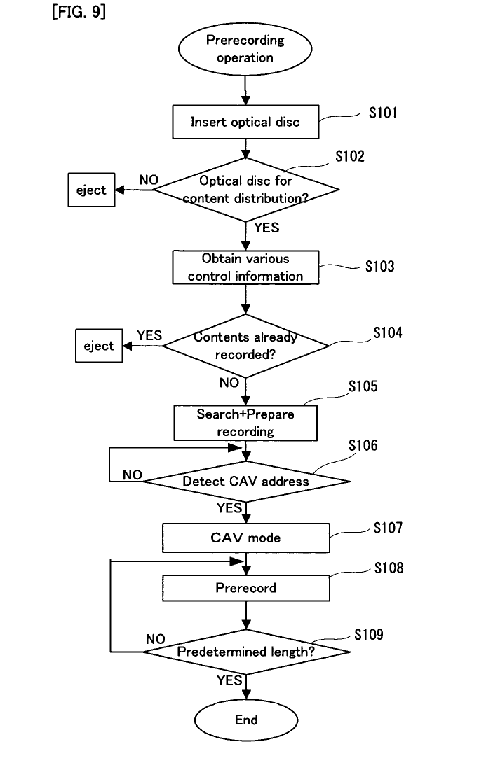

Next, with reference to FIG. 9, an explanation will be given for an operation of the prerecording apparatus, which is to prerecord the encryption information onto the information recording medium of the present invention. FIG. 9 is a flowchart showing the prerecording operation on the prerecording apparatus 200 in the embodiment.

Firstly, in FIG. 9, when the optical disc is inserted, firstly, a seek operation is performed by the optical pickup 202, under the control of the CPU (Central Processing Unit) 250 of the prerecording apparatus 200 (step S101).

Then, under the control of the CPU 250, it is judged whether or not the optical disc 100 is an optical disc for content distribution (step S102). Here, if the optical disc 100 is the optical disc for content distribution (the step S102: Yes), various control information and various management information necessary for the recording operation with respect to the optical disc 100 are determined or obtained (step S103). More specifically, an OPC process is performed to thereby determine an optimum recording power, and determine a recording strategy pattern. In addition, the presence or absence of an embossed pit is detected. Furthermore, start address information is obtained from the pre-format address information, such as the land pre-pit, wherein the start address information indicates a start position of the control data zone CDZ in which the CAV control method is applied.

Then, it is judged whether or not contents are already recorded on the optical disc 100 (step S104). Here, if the contents are not recorded on the optical disc 100 (the step S104: No), a predetermined address in which the encryption information is prerecorded is searched for, and the prerecording is prepared (step S105).

Then, under the control of the CPU 250, the start position of the control data zone CDZ in which the CAV control method is applied is searched for and detected on the basis of the obtained start address information (step S106). Here, if the start position of the control data zone CDZ is detected (the step S106: Yes), the output value of an applied voltage or current of the spindle motor is fixed, and an angular velocity is set constant on the basis of the CAV control method, under the control of the CPU 250 (step S107).

On the other hand, if the start position of the control data zone CDZ is not detected (the step S106: No), continuously, the start position of the control data zone CDZ in which the CAV control method is applied is detected on the basis of the obtained start address information, under the control of the CPU 250 (the step S106).

Then, under the control of the CPU 250, if the above-mentioned predetermined address is detected, the encryption information is prerecorded (step S108).

Then, under the control of the CPU 250, it is judged whether or not the encryption information is prerecorded only by a predetermined length (step S109). Here, if the encryption information is prerecorded only by the predetermined length (the step S109: Yes), a series of prerecording operation is ended.

On the other hand, if the encryption information is not prerecorded only by the predetermined length (the step S109: No), continuously, the encryption information is prerecorded (the step S108).

On the other hand, as a result of the judgment in the step S102, if it is judged not to be the optical disc for content distribution (the step S102: No), and as a result of the judgment in the step S104, if it is judged the contents are already recorded on the optical disc 100 (the step S104: Yes), then, the optical disc 100 is ejected from the prerecording apparatus 200.

(Entire Structure of Distribution System provided with Information Recording Medium, Information Recording Apparatus, and Information Distributing Apparatus)

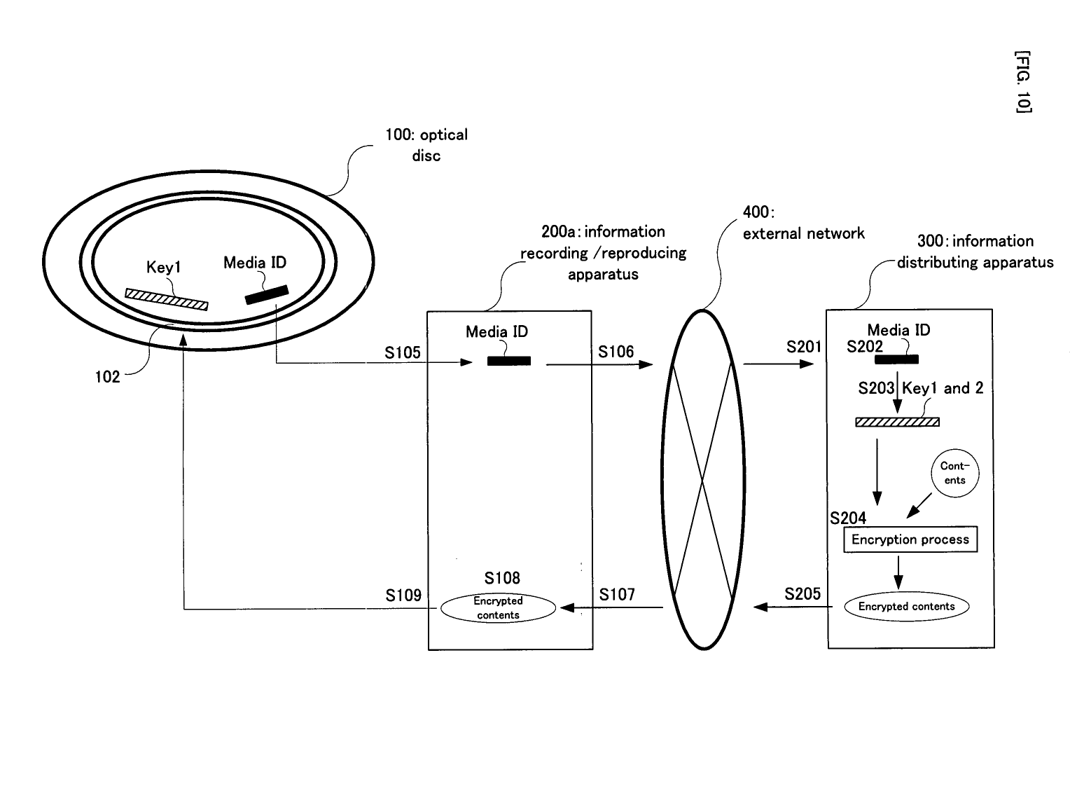

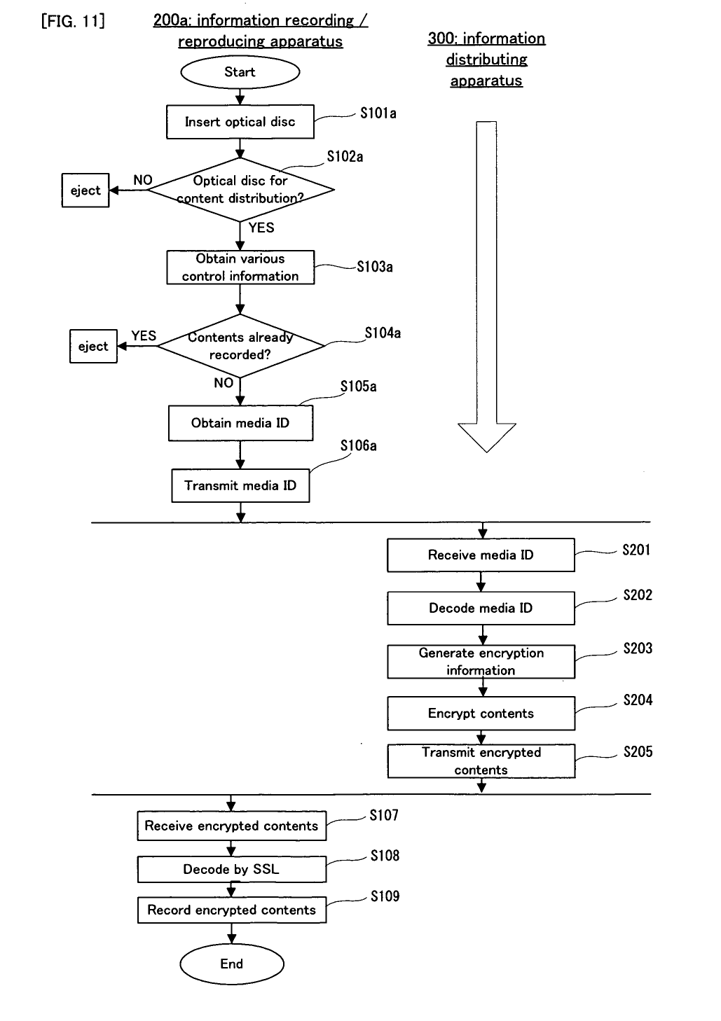

Next, with reference to FIG. 10, an explanation will be given for the entire structure of a distribution system, provided with: an information recording/reproducing apparatus for performing a general recording operation on the optical disc on which the encryption information is prerecorded; and an information distributing apparatus for performing a distribution operation. FIG. 10 is a block diagram showing the entire structure of the distribution system, provided with: the information recording apparatus for performing a general recording operation on the information recording medium of the present invention; and the information distributing apparatus for performing a distribution operation. Incidentally, step numbers in FIG. 10 correspond to those in FIG. 11 described later. Moreover, in the distribution system in the embodiment, a DAO (Disk At Once) method may be adopted.

As shown in FIG. 10, the distribution system in the embodiment is provided with: (i) the information recording/reproducing apparatus 200a for performing a recording operation on the optical disc 100; (ii) an information distributing apparatus 300, such as a web server, for distributing encrypted contents to the information recording/reproducing apparatus 200a; and (iii) the external network 400, such as the Internet, for allowing information to be exchanged between the information recording/reproducing apparatus 200a and the information distributing apparatus 300.

As described above, the optical disc 100 is provided with: the NBCA; the control data zone CDZ; and the data area 102 in which the encrypted contents are recorded. More specifically, in the NBCA, there is recorded the media ID by laser cutting. In the control data zone CDZ, there is recorded the encryption information Key1, such as a disk key. In the data area 102, there are recorded the encrypted contents or the like distributed by the information distributing apparatus 300 described later, as it is.

The information recording/reproducing apparatus 200a transmits the media ID of the optical disc 100 to the information distributing apparatus 300. Moreover, it records the encrypted contents received from the information distributing apparatus 300, onto the optical disc 100.

The information distributing apparatus 300 receives the media ID transmitted by the information recording/reproducing apparatus 200a. It generates the encryption information Key1, such as a disk key, corresponding to the received media ID, and the encryption information Key2, such as a title key. On the basis of the generated encryption information Key1 and Key2, the information distributing apparatus 300 performs an encryption process, such as encryption, on the contents. Then, it distributes the contents on which the encryption process is performed, i.e. the encrypted contents, to the information recording/reproducing apparatus 200a. Incidentally, the encrypted contents are distributed via the external network 400, so that encryption corresponding to eavesdropping and falsification or the like, such as a SSL (Secure Socket Layer), may be performed, aside from the encryption in the encryption process.

The external network 400 connects the information recording/reproducing apparatus 200a and the information distributing apparatus 300 so as to exchange the information, through a not-illustrated line connecting apparatus provided for the both apparatuses (e.g. a hub apparatus, a digital service unit (DSU), or a router with firewall application for preventing invasion mounted thereon).

(Distribution Process on Information Recording Medium, Information Recording Apparatus, and Information Distributing Apparatus)

Next, with reference to the above-mentioned FIG. 10 in addition to FIG. 11, an explanation will be given for a distribution process of the distribution system, provided with: the information recording/reproducing apparatus for performing the recording operation on the information recording medium of the present invention; and the information distributing apparatus for performing the distribution operation. FIG. 11 is a flowchart showing the distribution process on the information recording medium, the information recording apparatus, and the information distributing apparatus of the present invention. Incidentally, the step numbers in FIG. 11 correspond to those in FIG. 10.

(Operation on Information Recording Apparatus)

Firstly, in FIG. 11, if the optical disc 100 is inserted, the seek operation is performed by the optical pickup 202 under the control of the CPU (Central Processing Unit) 250 of the information recording/reproducing apparatus described later (step S101a).

Then, under the control of the CPU 250, it is judged whether or not the optical disc 100 is an optical disc for content distribution (step S102a). Here, if the optical disc 100 is the optical disc for content distribution (the step S102a: Yes), various control information and various management information necessary for the recording operation onto the optical disc 100 are obtained (step S103a). More specifically, an OPC process is performed, to thereby determine an optimum recording power and determine a recording strategy pattern.

Then, it is judged whether or not the contents are already recorded on the optical disc 100 (step S104a). Here, if the contents are not recorded yet on the optical disc 100 (the step S104a: No), the media ID peculiar to the optical disc 100 is obtained from the NBCA (Narrow Burst Cutting Area) on the optical disc 100 under the control of the CPU 250 (step S105a).

Then, under the control of the CPU 250, the obtained media ID is encrypted on the basis of the SSL or the like, and transmitted to the information distributing apparatus 300, such as a server on the network, for example (step S106a).

On the other hand, as a result of the judgment in the step S102a, if it is judged that the optical disc 100 is not the optical disc for content distribution (the step S102a: No), and as a result of the judgment in the step S104a, if it is judged that the contents are already recorded on the optical disc 100 (the step S104a: Yes), the optical disc 100 is ejected from the information recording/reproducing apparatus 200a.

(Operation on Information Distributing Apparatus)

On the information distributing apparatus 300, firstly the media ID encrypted by the SSL or the like is received (step S201).

Then, on the information distributing apparatus 300, the received media ID encrypted by the SSL or the like is decoded (step S202).

Then, on the information distributing apparatus 300, the encryption information Key1, such as a disk key, corresponding to the decoded media ID, and the encryption information Key 2, such as a title key, are generated (step S203).

Then, on the information distributing apparatus 300, contents and a file system distributed by using the generated encryption information Key1 and Key2 are encrypted in the predetermined encryption system (step S204).

Then, on the information distributing apparatus 300, the encrypted contents and file system, encrypted on the basis of the encryption system by using the generated encryption information Key1 and Key2, are further encrypted by the SSL or the like, and distributed to the information recording/reproducing apparatus 200a (step S205). More specifically, the attribute of the encrypted contents and file system encrypted by the SSL or the like, i.e. CCI (Copy Control Information), is set to the attribute of Never Copy so as not to be reproduced, in the middle of the distribution.

(Operation on Information Recording/Reproducing Apparatus—Continued—)

Again, on the information recording/reproducing apparatus 200a, the encrypted contents and file system, encrypted by the SSL or the like and distributed by the information distributing apparatus, are received (step S107a).

Then, on the information recording/reproducing apparatus 200a, the received encrypted contents and file system are decoded by the SSL or the like (step S108a).

Then, on the information recording/reproducing apparatus 200a, the encrypted contents and file system encrypted by using the encryption information Key1 and Key2, are not decoded and recorded onto the optical disc 100 as they are (step S109a). More specifically, the recording of the encrypted contents and file system encrypted on the basis of the predetermined encryption system, is started from the address of the last recording area of the lead-in area 101 which is not prerecorded, and it is ended at the address of the recording area of the lead-out area 103 which is pre-recorded. If the recording of the encrypted contents and file system is not performed up to the address of the recording area of the lead-out area 103 which is prerecorded, buffer data may be recorded up to this address. Incidentally, in the lead-in area 101 and the lead-out area 103 or the like, buffer data may be written in advance and sold, or buffer data may be newly written in the recording of the encrypted contents by the information recording/reproducing apparatus 200a.

As described above, the distribution system in the embodiment transmits and receives the media ID, instead of the encryption information Key1 and Key2, in exchanging the information through the external network 400 between the information recording/reproducing apparatus 200a and the information distributing apparatus 300. Therefore, it is possible to highly maintain the confidentiality of the encryption information Key1 prerecorded in the encryption information recording area (e.g., the control data zone CDZ); namely, it is possible to set a secure condition. Thus, it is hardly possible or not possible at all to prepare or manufacture the record-type information recording medium on which the encryption information Key1 is illegally copied.

(Flow of Reproduction Operation by Embodiment of Information Recording/Reproducing Apparatus)

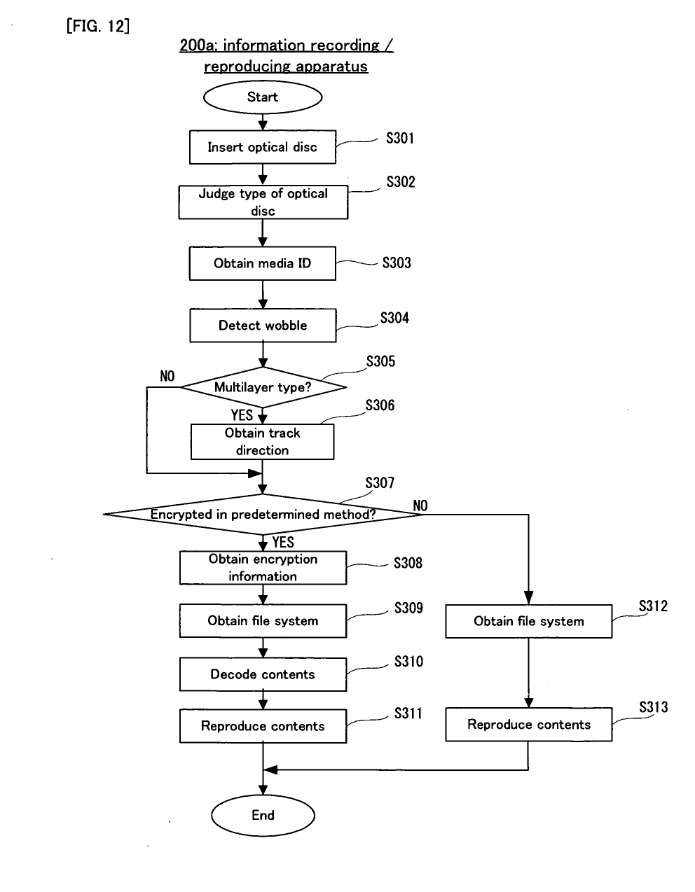

Next, with reference to FIG. 12, an explanation will be given for a reproduction operation in an embodiment of the information recording/reproducing apparatus for reproducing information on the information recording medium of the present invention. FIG. 12 is a flowchart showing a flow of the reproduction operation in one specific example of the embodiment of the information recording/reproducing apparatus of the present invention.

Firstly, in FIG. 12, if the optical disc 100 is inserted, the seek operation is performed by the optical pickup 202 under the control of the CPU 250 (step S301).

Then, under the control of the CPU 250, the type of the optical disc 100 is judged (step S302).

Then, under the control of the CPU 250, the media ID is obtained (step S303).

Then, under the control of the CPU 250, information about whether or not the optical disc 100 is the record-type information recording medium is obtained (step S304). More specifically, by judging whether or not the wobble or the like can be detected, it is possible to judge whether or not the optical disc 100 is the record-type information recording medium.

Then, under the control of the CPU 250, information about the number of recording layers of the optical disc 100 is obtained, and it is judged whether or not the optical disc 100 is a multilayer type information recording medium (step S305). Namely, under the control of the CPU 250, it is possible to judge whether or not the optical disc 100 is a single layer type or a multilayer type information recording medium, such as a dual-layer type. Here, if it is judged that the optical disc 100 is the multilayer type information recording medium, such as the dual-layer type (the step S305: Yes), information about the direction of the recording track of the optical disc 100 is obtained under the control of the CPU 250 (step S306). More specifically, it is possible to judge whether the optical disc 100 adopts a parallel method or an opposite method.

On the other hand, if it is judged that the optical disc 100 is not the multilayer type information recording medium, such as the dual-layer type (the step S305: No), the optical disc 100 is the single layer type information recording medium. Thus, the step S306 of obtaining the information about the direction of the recording track of the optical disc 100 is omitted.

Then, under the control of the CPU 250, it is judged whether or not the contents and the file system recorded in a user data area, for example, of the optical disc 100 are encrypted on the basis of the predetermine encryption system (step S307). Here, for example, if the contents recorded in the data area 102 of the optical disc 100 are encrypted on the basis of the encryption system (the step S307: Yes), the encryption information Key2, such as a title key, is obtained (step S308).

Then, under the control of the CPU 250, information about the file system of the optical disc 100 is obtained (step S309).

Then, under the control of the CPU 250, the contents encrypted and recorded on the optical disc 100 are decoded by using the obtained encryption information Key2, such as a title key, for example (step S310).

As descried above, under the control of the CPU 250, the reproduction is performed for each decoded content, by using the encryption information Key2, such as a title key, for example (step S311).

On the other hand, if the contents recorded in the user data area, for example, of the optical disc 100 are not encrypted on the basis of the encryption system (the step S307: No), the information about the file system is obtained under the control of the CPU 250 (step S312).

As described above, the contents are reproduced under the control of the CPU 250 (step S313).

In the embodiment, as one specific example of the information recording medium, the additional recording type (write-once type) optical disc, such as a CD-R or a DVD-R, for example, is explained. The present invention, however, can be also applied to an optical information recording medium, such as all types of CDs and DVDs which use the wobble, including a rewritable type optical disc, and a large-volume recording medium like a Blu-ray disc, for example.

The present invention is not limited to the above-described embodiment, and various changes may be made, if desired, without departing from the essence or spirit of the invention which can be read from the claims and the entire specification. An information recording medium which involves such changes, is also intended to be within the technical scope of the present invention.

### INDUSTRIAL APPLICABILITY

The information recording medium of the present invention can be applied to an information recording medium, such as a DVD.

1-13. (canceled)

14. An information recording medium, comprising:
a first record information recording area in which first record information can be recorded in a first rotational speed control method and in which a track is formed in a wobbling manner; and
a second record information recording area at least partially including a special area in which the track is not formed in a wobbling manner,
second record information being recorded in advance in the special area in a second rotational speed control method different from the first rotational speed control method.

15. The information recording medium according to claim 14, wherein (i) the first rotational speed control method is a rotational speed control method which enables a linear velocity to be constant, and (ii) the second rotational speed control method is a rotational speed control method which enables an angular velocity to be constant.

16. The information recording medium according to claim 15, wherein said second record information recording area includes a prerecorded area in which portion of the second record information is recorded in advance in the second rotational speed control method.

17. The information recording medium according to claim 14, wherein
wobble is formed in said first record information recording area by that a recording track for recording the first record information meanders, and
wobble in which at least one of frequency, amplitude, and phase is different from those of the wobble formed in said first record information recording area, is formed in the special area by that a recording track for recording portion of the second record information meanders.

18. The information recording medium according to claim 14, wherein
(i) a land track and a groove track are alternately formed in said first record information recording area as a recording track, and (ii) land pre-pits carrying predetermined types of pre-information are formed in advance on the land track, and
the land pre-pits are not recorded in the special area.

19. The information recording medium according to claim 18, wherein the land track and the groove track are formed in the special area.

20. The information recording medium according to claim 14, wherein
a land track and a groove track are alternately formed in said first record information recording area as a recording track, and
the land track and the groove track are not recorded in the special area.

21. The information recording medium according to claim 15, further comprising a control information recording area in which control information about reproduction and recording control can be recorded,
at least one of start address information and end address information being recorded in the control information recording area, the start address information indicating a start position of said second record information recording area, the end address information indicating an end position of said second record information recording area.

22. The information recording medium according to claim 15, wherein
pre-format address information is recorded in at least one of said first record information recording area and said second record information recording area, and
at least one of start address information and end address information is appended to the pre-format address information, the start address information indicating a start position of said second record information recording area, the end address information indicating an end position of said second record information recording area.

23. The information recording medium according to claim 14, wherein the second record information is encryption information for encrypting the first record information.

24. The information recording medium according to claim 14, wherein
the second record information is information for further encrypting another encryption information for encrypting the first record information,
the another encryption information is recorded into said first record information recording area with the first record information.
